(19) United States
(12) Patent Application Publication
(10) Pub. No.: US 2024/0288321 A1
(43) Pub. Date: Aug. 29, 2024

(54) APPARATUSES FOR SENSING PRESSURE

(71) Applicant: Noxware Ltd., Toronto (CA)

(72) Inventors: Omid Mokhtari, Toronto (CA); Hossein Zereshkian, Richmond Hill (CA)

(21) Appl. No.: 18/441,764

(22) Filed: Feb. 14, 2024

Related U.S. Application Data
(60) Provisional application No. 63/448,470, filed on Feb. 27, 2023.

(51) Int. Cl. G01L 1/04; G01L 1/18

(52) U.S. Cl. CPC G01L 1/04; G01L 1/18

(57) ABSTRACT

There is provided an apparatus for sensing pressure. The apparatus may include a deformable layer being reversibly deformable by the pressure. The deformable layer may have a first side and a second side opposite the first side. The apparatus may also include an electrically-active (EA) layer disposed proximate the first side of the deformable layer. The EA layer may have an electrical property that is reversibly changeable when the EA layer is subjected to the pressure. Moreover, the apparatus may include a plurality of pins being electrically conductive and each having a first end and a second end opposite the first end. The pins may extend from the second side, through the deformable layer, to the first side such that the pins electrically contact the EA layer proximate the first ends. The electrical property may be measurable between a pair of the pins.

### CROSS-REFERENCE TO RELATED APPLICATION

This application claims priority from U.S. Provisional Patent Application No. 63/448,470, filed on Feb. 27, 2023, which is incorporated herein by reference in its entirety.

### FIELD

The present specification relates to apparatuses for sensing, and in particular to apparatuses for sensing pressure.

### BACKGROUND

Different apparatuses may be used to sense or measure different parameters affecting those apparatuses or present in the environment of the apparatuses. One such parameter may include pressure. Some examples of such apparatuses may be used to sense a pressure applied to those apparatuses.

### SUMMARY

According to an aspect of the present specification there is provided an apparatus for sensing pressure, the apparatus comprising: a deformable layer being reversibly deformable by the pressure, the deformable layer having a first side and a second side opposite the first side; an electrically-active (EA) layer disposed proximate the first side of the deformable layer, the EA layer having an electrical property that is reversibly changeable when the EA layer is subjected to the pressure; and a plurality of pins being electrically conductive and each having a first end and a second end opposite the first end, the pins extending from the second side, through the deformable layer, to the first side such that the pins electrically contact the EA layer proximate the first ends, the electrical property being measurable between a pair of the pins.

The EA layer may comprise an E-textile.

The electrical property may comprise an electrical resistance of the E-textile.

The pressure may to be applied to the E-textile to cause the deformable layer to deform and the E-textile to stretch, the stretching causing the electrical resistance of the E-textile to change.

The deformable layer may comprise a foam.

The foam may comprise a latex foam.

The electrical property may be measurable proximate the second ends of the pins.

The second ends of the pins may be proximate the second side.

The apparatus may further comprise a substrate layer being electrically conductive, the substrate layer disposed proximate the second side and in electrical contact with the second ends of the pins.

The substrate layer may be flexible.

The apparatus may further comprise a first additional deformable layer disposed on a side of the substrate layer opposite the deformable layer.

The apparatus may further comprise a second additional deformable layer disposed on a corresponding side of the EA layer opposite the deformable layer.

One or more of the first additional deformable layer and the second additional deformable layer may comprise a corresponding foam.

The apparatus may further comprise a data acquisition module electrically connected to the substrate layer.

The EA layer may be shaped as a strip having a length that is larger than its width.

The length may be at least about 10 times larger than the width.

The pins may be arranged single file along the length of the strip of the EA layer.

The EA layer may be shaped as a strip having a length that is larger than its width; the pins may be arranged single file along the length of the strip of the EA layer; and the substrate layer may be shaped as a corresponding strip having a corresponding length that is larger than its corresponding width, the strip of the EA layer aligned with the corresponding strip of the substrate layer.

The apparatus may comprise a mat.

The mat may be placed on a support substrate positioned proximate the second side, and the pressure may be applied by a weight of an entity placed on the mat proximate the first side.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a side elevation cross-sectional view of an example apparatus for sensing pressure, in accordance with a non-limiting implementation of the present specification.

FIG. 2 shows a top plan view of another example apparatus for sensing pressure, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like.

Moreover, in the following description, elements may be described as “configured to” or “to” perform one or more functions, or “configured for” or “for such functions. In general, an element that is configured to or to perform or configured for or for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

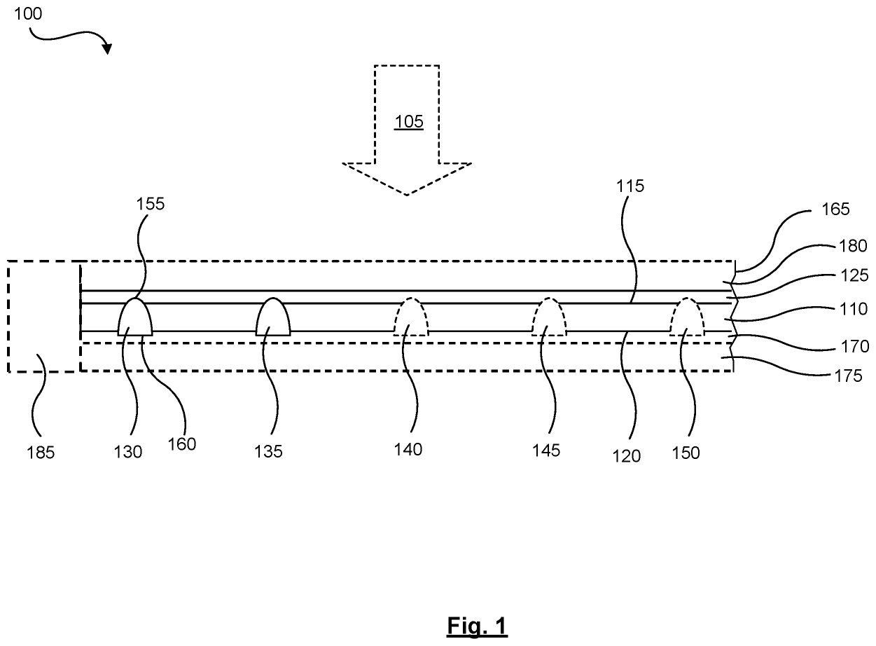

FIG. 1 shows a side elevation, cross-sectional view of a schematic representation of an example apparatus 100 for sensing pressure. An example of such pressure may be a pressure represented by arrow 105 shown in FIG. 1. While arrow 105 is shown at a particular position and orientation relative to apparatus 100, it is contemplated that apparatus 100 may be able to sense pressures applied at positions and orientations other than those shown in FIG. 1. Although FIG. 1 is a cross-sectional view, the depictions of the various components in FIG. 1 are not cross-hatched, for ease and clarity of illustration.

Apparatus 100 comprises a deformable layer 110, which may be reversibly deformable by a pressure applied to apparatus 100, such as a pressure represented by arrow 105. In other words, the pressure may deform layer 110, and when the pressure is removed, layer 110 may completely or substantially return to its original shape. Deformable layer 110 may also be referred to as layer 110 in short. Layer 110 has a first side 115 and a second side 120 opposite first side 115. In some examples, layer 110 may comprise a foam, such as a latex foam and the like.

Apparatus 100 also comprises an electrically-active (EA) layer 125 disposed proximate side 115 of layer 110. In other words, EA layer 125 is on the side of layer 110 near or proximate first side 115. EA layer 125 may also be referred to as layer 125 in short. In some examples, layer 125 may be touching or abutting layer 110 along some or all of first side 115. It is also contemplated that in some examples, layer 125 may be adjacent or near first side 115 of layer 110. In some such example a gap or one or more other layers or components may be interposed between layers 110 and 125.

EA layer 125 has an electrical property that is reversibly changeable when EA layer 125 is subjected to a pressure, such as a pressure represented by arrow 105. In other words, the electrically property may change when the EA layer is subjected to the pressure, which change may be completely or substantially reversed when the pressure is removed. In some examples, EA layer 125 may comprise an E-textile and the electrical property may comprise the electrical resistance of the E-textile. In some examples, E-textiles may comprise fibers that are electrically conductive, elastic, or both. A pressure applied to apparatus 100, such as a pressure applied along arrow 105, pushes EA layer 125 into deformable layer 110. Such a pressure causes layer 110 to deform and layer 125 to deform and stretch. Such stretching may length and also press or force fibers of the E-textile together or apart, thereby changing the dimensions of the passage through the E-textile for electrons, and producing a corresponding change in the electrical resistance of the E-textile in the area of the stretching. When the pressure is removed, the elasticity of the E-textile cases it to return completely to substantially to its original, un-stretched dimensions, which in turn causes the pressure-induced change to electrical resistance to be completely to substantially revered as well.

Such a pressure-induced change or reduction in electrical resistance could then be measured between two electrically conductive contact points such as pins 130 and 135. As shown in FIG. 1, apparatus 100 comprises a plurality of pins 130, 135, 140, 145, and 150. These pins are electrically conductive. The pins may be similar to one another in shape and size, as shown in FIG. 1. It is also contemplated that in some examples the pins may be different from one another. In relation to FIG. 1, the parts and positioning of the pins will be described in relation to pin 130, which description also applies to the other pins in FIG. 1.

Pin 130 has a first end 155 and a second end 160 opposite first end 155. Pin 130 extends from second side 120, through deformable layer 110, and to first side 115 such that pin 130 electrically contacts EA layer 125 proximate first end 155. In other words, pin 130 extends through layer 110 such that first end 155 is proximate side 115 and electrically contacts layer 125 and second end 160 is proximate side 120. In this way, the changeable electrical property of EA layer 125 can be measured between a pair of pins, such as pins 130 and 135. The number of pins, and the distance between the pins may determine the spatial resolution with which the changes in the electrical properties of EA layer 125, and the pressure causing those changes, may be measured or sensed across apparatus 100.

In FIG. 1, apparatus 100 is shown as having five pins 130, 135, 140, 145, and 150. Pins 130 and 135 are shown in solid lines to indicate that a pair of pins are used to measure the electrical property of EA layer 125 therebetween. Pins 140, 145, and 150 are shown in dashed lines to indicate that in some examples apparatus 100 need not comprise one or more of pins 140, 145, and 150. It is also contemplated that in some examples apparatus 100 may comprise a plurality of pins whose number may be larger or fewer than those shown in FIG. 1.

In addition, in FIG. 1 pins 130, 135, 140, 145, and 150 are shown as being about evenly spaced along layer 110. It is contemplated that in some examples the pins may have an arrangement, distribution, or spacing different than those shown in FIG. 1. Moreover, in FIG. 1 the pins are shown as having a rounded conical shape. It is contemplated that in some examples the pins may have a shape other than that shown in FIG. 1.

It is also contemplated that in some examples one or more of the pins may be made of a rigid material, or a flexible material. A rigid material may be a material that does not deform appreciably under a pressure applied to apparatus 100, such as a pressure applied along arrow 105. A flexible material may be a material that does deform appreciably when subjected to such a pressure. Such a deformation may be reversible.

Furthermore, it is contemplated that in some examples the relative sizes or proportions of the components of apparatus 100 may be different than those shown in FIG. 1. In FIG. 1 side 165 of apparatus 100 is shown using a jagged line, to indicate that apparatus 100 may be larger or extend further in that direction (i.e. in the in-plane direction of layers 110 and 125) beyond jagged line of side 165.

Since first end 155 of pin 130 is in contact with EA layer 125 and pin 130 is electrically conductive, changes to the electrical properties of EA layer 125 may be measured proximate second end 160 of pin 130. The same may be true of the other pins. Proximate, used herein, may mean at, near, or on the same side of, unless the context dictates otherwise. As shown in FIG. 1, in apparatus 100 the second ends of the pins are proximate second side 120 of deformable layer 110.

In some examples, apparatus 100 may further comprise a substrate layer 170, which layer may be electrically conductive. Layer 170 is disposed proximate second side 120 and is in electrical contact with the second ends (such as end 160) of the pins. This substrate layer 170 may include, or act as, electrical contacts to the second ends of the pins to allow for capturing electrical measurement data from the second ends of the pins. In some examples, substrate layer 170 may comprise multiple separate conductive channels, with each channel being connected to one of the pins. Moreover, in some examples, substrate layer 170, including its one or more conductive channels, may be flexible.

In FIG. 1 substrate layer 170 is shown in dashed lines to indicate that in some examples apparatus 100 need not comprise a substrate layer. In such examples, electrical contact to the pins may be implemented in a different way, such as using wires, electrical leads, printed electronics, and the like.

In some examples, apparatus 100 may also comprise one or more additional deformable layers. For example, apparatus 100 may comprise a first additional deformable layer 175 disposed on a substrate 170 opposite layer 110. In other words, layer 175 may be proximate, or on the same side as, second side 120 of layer 110. Apparatus 100 may also comprise a second additional deformable layer 180 disposed on a side of EA layer 125 opposite deformable layer 110.

In some examples, one or both of additional deformable layers 175 and 180 may comprise a foam, which foam may comprise latex foam, and the like. In FIG. 1 layers 175 and 180 are shown in dashed lines to indicate that in some examples apparatus 100 need not comprise one or both of layers 175 and 180.

Furthermore, in some examples, apparatus 100 may further comprise a data acquisition module 185, which module may be electrically connected to the pins. In apparatus 100 module 185 may be electrically connected to substrate 170, which substrate is in turn electrically connected to the pins. It is also contemplated that in some examples, module 185 may be connected to the pins using a connector other than substrate 170.

In some examples, module 185 may comprise one or more of a machine readable memory to store data related to measurements of electrical properties, a processor to process such data, and a power source. In some examples, the memory may comprise a non-transitory machine-readable storage medium which may comprise an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, and the like.

Moreover, in some examples, the processor may comprise a central processing unit (CPU), a graphics processing unit (GPU), a microcontroller, a microprocessor, a processing core, a field-programmable gate array (FPGA), or similar device capable of executing instructions. In addition, in some examples the power source may comprise a portable power source such as a battery. In FIG. 1, module 185 is shown in dashed lines to indicate that in some examples apparatus 100 need not comprise a data acquisition module. In some such examples, the data acquisition, storage, or processing may be performed in a module separate from apparatus 100.

In some examples, apparatus 100 and the other pressure-sensing apparatuses described herein may act or be used as, or may form a part of, a mat or a mattress. In some such examples, the additional deformable layers 175 and 180 may add to the comfort of the mat or mattress. Such a mat or mattress may be placed on a support substrate positioned proximate, or on the same side as, second side 120, and the pressure to be sensed by the mat or mattress may be applied by the weight of an entity placed on the mat or mattress proximate, or on the same side as, first side 115. Examples of the support substrate may include a bed frame, the ground or floor, and the like. Examples of the entity whose weight is placed on the mat or matters may include a person sitting or laying on the mat or mattress.

In some examples, the ability to detect pressure exerted by a person laying on such a pressure-sensing mat or mattress may be used to sense relatively high pressure points that may cause or increase the risk of pressure ulcers in persons with reduced mobility. Detection of an increased risk of pressure ulcers may allow for passive or active interventions to prevention or lower the risk of pressure ulcers.

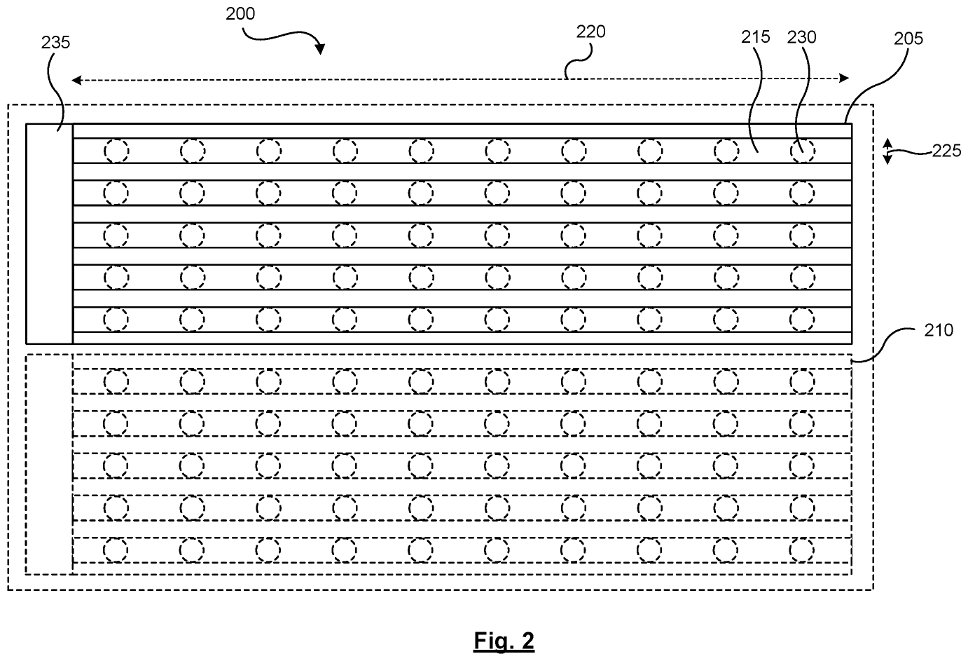

In addition, in some examples, apparatus 100 may be in the form of modules that may be grouped or used together to form, or as part of, a larger device such as a mat, mattress, and the like. FIG. 2 shows a top plan view of a schematic representation of a device 200 that incorporates two pressure-sensing apparatuses 205 and 210. Apparatuses 205 and 210 may be the same as, or similar to, apparatus 100. In some examples, device 200 may comprise a mat, mattress, or the like.

In FIG. 2 apparatus 210 is shown in dashed lines to indicate that in some examples device 200 need not comprise apparatus 210. It is also contemplated that in some examples, device 200 may include more than two modular apparatuses similar to apparatuses 205 and 210.

The components and layered structure of apparatus 205 may be similar to those of apparatus 100. Apparatus 205 comprises an EA layer 215, which may be similar to EA layer 125 of apparatus 100. EA layer 215 is shaped as a strip having a length 220 that is larger than its width 225. In some examples, the strip may have a length 220 than is at least about 10 times larger than width 225. Other shapes and relative dimensions of EA layer 215 are also contemplated.

Apparatus 205 also comprises pins, such as pin 230. These pins may be similar to pins 130, 135, 140, 145, and 150 of apparatus 100. The pins in apparatus 205 are shown in dashed lines to indicate that tips or ends of the pins need not puncture EA layer 215, in which case in the top plan view of FIG. 2 the pins would be obscured by EA layer 215 in apparatus 205. It is also contemplated that in some examples the tips or ends of the pins may puncture or pass through the EA layer.

As shown in FIG. 2, the pins in apparatus 205 are arranged single file along the length of the strip of EA layer 215. It is also contemplated that in some examples the pins may be arranged and distributed differently relative to the EA layer. Apparatus 205, in turn, has multiple strips of EA layers with pins arranged single file along each layer. While FIG. 2 shows apparatus 205 as having 5 strips of EA layers with 10 pins per each strip, it is contemplated that in some examples apparatus 205 may have a number and arrangement of strips, and a number and arrangement of pins per strip, that may be different than those shown in FIG. 2.

In some examples, apparatus 205 may comprise a support layer similar to support layer 170 of apparatus 100. This support layer is not visible in FIG. 2 because it is obscured by other layers. It is contemplated that in some examples the support layer may also be shaped as strips similar to the strips of the EA layer, with each strip of the support layer having a length that is larger than its corresponding width. Moreover, in some examples, these strips of the support layer may be aligned with the corresponding strips of the EA layer. This alignment, in turn, would allow the pins to connect at one end to the EA layer and at the other end to the support layer.

Such support layers, in turn, may be electrically connected to a data acquisition module 235, which may be similar to module 185 of apparatus 100. As discussed in relation to apparatus 100, it is contemplated that in some examples, apparatus 205 need not comprise a data acquisition module, and that the functions of such a module would be performed by a module or component outside of apparatus 205.

Throughout this specification and the appended claims, infinitive verb forms are often used. Examples include, without limitation: “to deform,” “to change,” “to stretch,” and the like. Unless the specific context requires otherwise, such infinitive verb forms are used in an open, inclusive sense, that is as “to, at least, deform,” to, at least, change,” “to, at least, stretch,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An apparatus for sensing pressure, the apparatus comprising:
a deformable layer being reversibly deformable by the pressure, the deformable layer having a first side and a second side opposite the first side;
an electrically-active (EA) layer disposed proximate the first side of the deformable layer, the EA layer having an electrical property that is reversibly changeable when the EA layer is subjected to the pressure; and
a plurality of pins being electrically conductive and each having a first end and a second end opposite the first end, the pins extending from the second side, through the deformable layer, to the first side such that the pins electrically contact the EA layer proximate the first ends, the electrical property being measurable between a pair of the pins.

2. The apparatus of claim 1, wherein the EA layer comprises an E-textile.

3. The apparatus of claim 2, wherein the electrical property comprises an electrical resistance of the E-textile.

4. The apparatus of claim 3, wherein the pressure is to be applied to the E-textile to cause the deformable layer to deform and the E-textile to stretch, the stretching causing the electrical resistance of the E-textile to change.

5. The apparatus of claim 1, wherein the deformable layer comprises a foam.

6. The apparatus of claim 5, wherein the foam comprises a latex foam.

7. The apparatus of claim 1, wherein the electrical property is measurable proximate the second ends of the pins.

8. The apparatus of claim 1, wherein the second ends of the pins are proximate the second side.

9. The apparatus of claim 8, further comprising a substrate layer being electrically conductive, the substrate layer disposed proximate the second side and in electrical contact with the second ends of the pins.

10. The apparatus of claim 9, wherein the substrate layer is flexible.

11. The apparatus of claim 8, further comprising a first additional deformable layer disposed on a side of the substrate layer opposite the deformable layer.

12. The apparatus of claim 10, further comprising a second additional deformable layer disposed on a corresponding side of the EA layer opposite the deformable layer.

13. The apparatus of claim 11, wherein one or more of the first additional deformable layer and the second additional deformable layer comprise a corresponding foam.

14. The apparatus of claim 9, further comprising a data acquisition module electrically connected to the substrate layer.

15. The apparatus of claim 1, wherein the EA layer is shaped as a strip having a length that is larger than its width.

16. The apparatus of claim 15, wherein the length is at least about 10 times larger than the width.

17. The apparatus of claim 15, wherein the pins are arranged single file along the length of the strip of the EA layer.

18. The apparatus of claim 9, wherein:
the EA layer is shaped as a strip having a length that is larger than its width;
the pins are arranged single file along the length of the strip of the EA layer; and
the substrate layer is shaped as a corresponding strip having a corresponding length that is larger than its corresponding width, the strip of the EA layer aligned with the corresponding strip of the substrate layer.

19. The apparatus of claim 1, wherein the apparatus comprises a mat.

20. The apparatus of claim 19, wherein the mat is to be placed on a support substrate positioned proximate the second side, and the pressure is to be applied by a weight of an entity placed on the mat proximate the first side.
